(19) United States
(12) Patent Application Publication
(10) Pub. No.: US 2005/0044740 A1
(43) Pub. Date: Mar. 3, 2005

(54) Fractional measuring caliper

(76) Inventor: Andrew H. Hansen, Round Lake, IL (US)

Correspondence Address: Kristin Davenport, P.O. Box 770, Richland, MI, 49083, US

(21) Appl. No.: 10/925,354

(22) Filed: Aug. 24, 2004

Related U.S. Application Data
(60) Provisional application No. 60/497,738, filed on Aug. 25, 2003.

(51) Int. Cl. G01B 5/00

(52) U.S. Cl. 33/783

(57) ABSTRACT

A fractional measuring caliper includes first and second measuring arms which are relatively movable to determine a dimension of a member and a third arm that is movable in response to the relative movement of the first and second arms to measure a predetermined fractional extent of the dimension.

This application claims the benefits and priority of U.S. provisional application Ser. No. 60/497,738 filed Aug. 25, 2003.

### CONTRACTUAL ORIGIN OF THE INVENTION

The invention described in this application was made under a grant from the Department of Education (National Institute on Disability and Rehabilitation Research), Grant No. H133E980023. The Government may have certain rights in the invention.

### FIELD OF THE INVENTION

The present invention relates to a fractional measuring caliper for measuring a fractional extent (e.g. ½, ⅓, etc.) of a dimension of a member.

### BACKGROUND OF THE INVENTION

In the construction and repair of articles of manufacture, workers are often faced with the task of finding the center of a dimension of a component or member. For example, the worker may wish to cut a wood board exactly in half or to drill a hole at precisely the center point of a steel bar. In the past, the worker typically would manually measure the width dimension of the member and then divide the measured dimension in half to accomplish this task. Both the measurement and the mathematical division increase the probability of human error and, in some cases, may lead to the accidental scrapping or destruction of the member as a result of an incorrect location of the cut, hole, etc.

### SUMMARY OF THE INVENTION

The present invention provides a fractional measuring caliper that eliminates the need for the above manual measurement and mathematical division steps. The fractional measuring caliper can be constructed to measure any fractional extent of a dimension pursuant to the invention. For example, the fractional measuring caliper can be embodied as a bisecting caliper where its function is to bisect or measure one half of the dimension. The fractional measuring caliper alternately can be embodied as a trisecting caliper where its function is to measure a one third of the dimension.

In an illustrative embodiment of the invention, the fractional measuring caliper comprises first and second measuring arms which are relatively movable to determine a dimension of a member. A third measuring arm is provided and is movable in response to the relative movement of the first and second measuring arms to measure a predetermined fractional extent (e.g. 1/n) of the dimension, such as ½, ⅓, ¼, etc. of the dimension. To this end, the third measuring arm can be driven to move in such a manner by a drive train, such as a rack and gear drive mechanism or differential pitch screw drive mechanism, that is selected to convert the relative movement of the first and second measuring arms to a desired fractional movement of the third measuring arm.

Advantages of the present invention will become more readily apparent from the following detailed description of the invention taken with the following drawings.

### DESCRIPTION OF THE DRAWINGS

FIG. 1 is a schematic view of a fractional measuring caliper pursuant to an illustrative embodiment of the invention using a rack and gear mechanism to move the third measuring arm.

FIG. 2 is a schematic view of a fractional measuring caliper pursuant to an illustrative embodiment of the invention using a differential pitch screw drive mechanism to move the third measuring arm.

### DESCRIPTION OF THE INVENTION

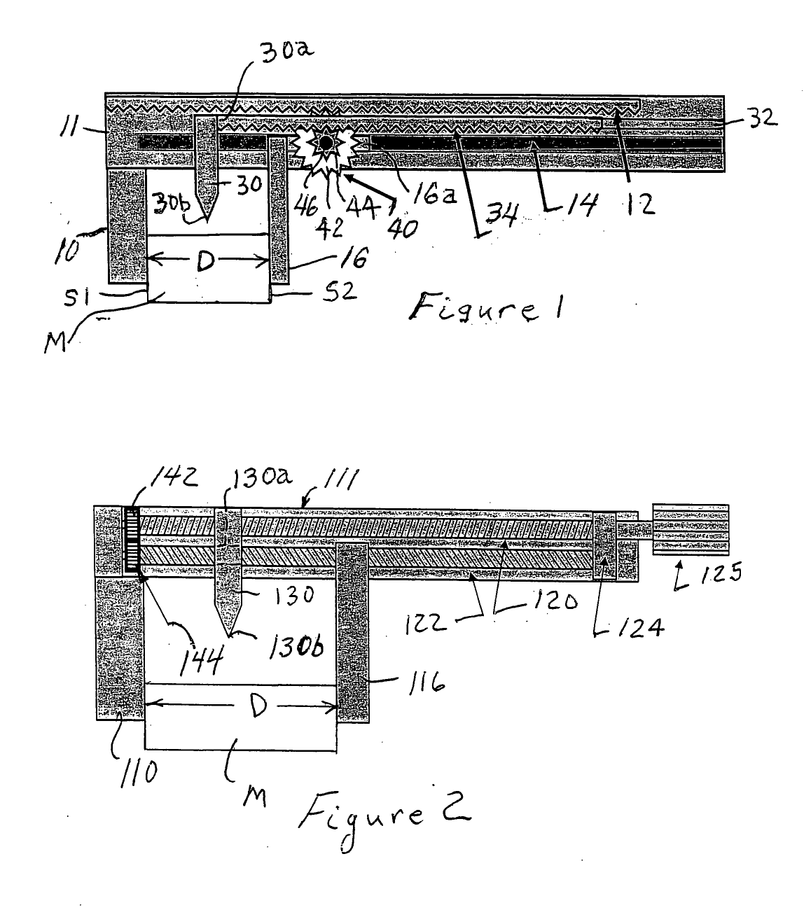

Referring to FIG. 1, a fractional measuring caliper pursuant to an illustrative embodiment of the invention is shown comprising a first measuring arm 10 which can be part of or connected to a caliper body 11. The first measuring arm 10 is referred to as the reference arm since movements of second and third measuring arms described below are made with respect to the first measuring arm 10. The caliper body 11 can be made of metal, plastic, or any other material and includes a stationary toothed rack 12 and an elongated groove 14 to receive an extension 16a of a second movable measuring arm 16. The stationary toothed rack 12 can be separately or integrally formed with the caliper body 11 and the arm extension 16a can be an integral part of or connected to the measuring arm 16. The arm extension 16a is received in groove 14 for sliding movement back and forth as in a conventional vernier measuring caliper.

The measuring arms 10, 16 are relatively moved to engage respective opposite side surfaces S1, S2 defining a dimension D of a member M, which can comprise any object or article to be measured. Those skilled in the art can appreciate that either one or both of the measuring arms 10, 16 can be movable for engaging the respective opposite side surfaces S1, S2. The gear 42 described below can function as a thumb wheel by which the second measuring arm 16 is moved along the groove 14 relative to the stationary measuring (reference) arm 10 by a worker using the caliper until the arm 16 engages side surface S2 and the arm 10 engages side surface S1 as shown in FIG. 1. Such relative movement of arms 10, 16 thereby can be used to determine or measure the dimension D of the member M as in a conventional vernier caliper. A third measuring arm 30 moves in response to the relative movement of the first and second measuring arms 10, 16 to measure a predetermined fractional extent of the dimension D, 1/n. An indicator dial or electronic digital or other display (not shown) can be provided on the caliper in conventional manner to display the measured dimension D and, if desired, the fractional measurement 1/n. Moreover, a drill guide, center punch, or other mechanical tool attachment may be provided on the third arm 30 for use in certain applications.

Pursuant to the invention, the third measuring arm 30 has an arm extension 30a which can be part of or connected to the third measuring arm 30. The third measuring arm 30 is mounted on the caliper body 11 for linear movement in response to the relative movement between the first and second measuring arms 10, 16 in a direction parallel with the groove 14. For example, the third measuring arm 30 can be mounted for sliding movement in a parallel groove 32 in a manner similar to that used to mount the movable second arm extension 16a for linear movement in groove 14. The third measuring arm 30 could also be guided by a straight member or piece that would be mounted on top of the fixed rack 12 and that would engage and guide the adjacent flat side of the moving, toothed rack 34, keeping rack 34 parallel to the groove 14 and without interfering with gear 42. The third measuring arm 30 includes a toothed rack 34 along its extension 30a.

A gear drive train 40 is provided to move the third measuring arm 30 a predetermined fractional extent of the total relative displacement of the first and second arms 10, 16 when they are relatively moved to engage side surfaces S1, S2. The drive train 40 is shown comprising a first larger diameter toothed gear 42 in meshing engagement with the toothed rack 12 on the caliper body 11 and a smaller diameter toothed gear 44 in meshing engagement with the toothed rack 34 on the third arm extension 30a. The gears 42, 44 are coaxially and rotatably stacked atop one another on a common shaft 46 affixed to the second arm extension 16a such that linear movement of the second arm 16 causes rotation of the gear 42 by virtue of its engagement with toothed rack 12 and in turn rotation of gear 44. Rotation of gear 44 drives the toothed rack 34 on the third arm extension 30a and thereby drives the third measuring arm 30 to move linearly between measuring arms 10, 16. The ratio of the diameters of the gears 42, 44 is selected to drive the third measuring arm 30 a predetermined fractional extent of the total relative displacement of the first and second arms 10, 16. For example, in FIG. 1, the smaller gear 44 has half the diameter of the larger gear 42 so that the pointer indicator 30b formed on the third measuring arm 30 will point to ½ of the dimension D of the member M when measuring arms 10, 16 engage surfaces S1, S2 as shown in FIG. 1. In an embodiment of the invention to provide a trisecting measuring caliper, the smaller gear 44 would have a diameter that is one third that of the larger gear 42. Other fractional measuring calipers can be constructed in similar fashion by appropriate selection of the ratio of diameters of gears 42, 44.

Referring to FIG. 2, a fractional measuring caliper pursuant to a different illustrative embodiment of the invention is shown comprising a stationary first measuring (reference) arm 110 that can be part of or connected to a caliper body 111, a second movable measuring arm 116 for movement relative to measuring arm 110, and a third measuring arm 130 for measuring a predetermined fractional extent (e.g. 1/2, 1/3, etc. of dimension D) of the total relative displacement of the first and second arms 110, 116. The caliper of this embodiment includes first and second parallel screws 120, 122 having a different pitch. The second measuring arm 116 is threadably mounted and engaged on screw 122 to move with rotation of screw 122. The screws 120, 122 are mounted at the left hand ends in FIG. 2 in the caliper body 111 and at the right hand ends in a free bearing housing 124 that holds the screws in position but allows them to turn or rotate freely. The screw 120 includes an axial extension with a manual rotatable knob 125 at its end by which the screw 120 is rotated by the worker using the caliper. The screw 120 is coupled to the screw 122 by a pair of gears 142, 144 mounted thereon. As the screw 120 rotates, the second screw 122 is rotated in the reverse direction. The second screw 122 has a pitch equal to −(n×P) where n is the inverse of the fractional measurement (e.g. ½, ⅓, etc. of dimension D) that is desired and P is the pitch of the screw 120. The negative sign refers to a reverse thread pattern on screw 122. The screw mechanism described forces the screws to turn in opposite directions regardless of their pitch. The reverse pitch allows opposite rotations of the two screws to move their threaded engagement pieces in the same direction.

The third measuring arm 130 moves a predetermined fractional extent by a screw drive mechanism in response to the movement of the first and second arms 110, 116. The third measuring arm 130 is threadably mounted and engaged on screw 120 such that the measuring arm 130 is moved the fractional extent by rotation of the screw 120. The third arm 130 includes a hole 130a large enough to allow the screw 122 to pass through the third arm 130 without any threaded engagement therewith. The third measuring arm 130 can be located somewhat above the first and second measuring arms 110, 116 so that they can be closed together. For a bisecting measuring caliper, the value of “n” set forth in the preceding paragraph would be equal to 2. For a trisecting measuring caliper, the value of “n” would be equal to 3, and so on. The third measuring arm 130 includes a pointer indicator 130b that points to the fractional extent of dimension D.

In the embodiment of FIG. 2, the screws 120, 122 can have the same pitch but reversed. Also, the gear ratio of gears 142, 144 can be different and selected as desired.

The present invention provides a fractional measuring caliper that can be sold as a tool to measure a predetermined fractional extent of a dimension of a member by a worker. Multiple fractional calipers of the type described each constructed to measure a different predetermined fractional extent of a dimension can be sold as a tool set for use by the worker as needed for different fractional measurements. Moreover, a fractional caliper pursuant to still another embodiment of the invention may be modified so as to be capable of measuring different, multiple predetermined fractional extents of a dimension using a single caliper.

Although the invention has been described above with respect to certain embodiments, those skilled in the art will appreciate that the invention is not limited to these embodiments since modifications, changes, and the like can be made therein without departing from the spirit and scope of the invention as set forth in the appended claims.

1. A fractional measuring caliper, comprising first and second measuring arms which are relatively movable to determine a dimension of a member and a third arm that is movable in response to said relative movement to measure a predetermined fractional extent of the dimension.

2. The caliper of claim 1 wherein the third arm measures 1/n of the dimension where 1/n is any fraction.

3. The caliper of claim 2 wherein the third arm measures ½ of the dimension.

4. The caliper of claim 2 wherein the third arm measures ⅓ of the dimension.

5. The caliper of claim 1 wherein the third arm is moved the fractional extent by a gear drive train.

6. The caliper of claim 1 wherein the third arm is moved the fractional extent by a screw drive mechanism.

7. A method for measuring a predetermined fractional extent of a dimension comprising relatively moving a first and a second measuring arms to determine the dimension of a member and moving a third arm in response to said relative movement of the first and second arms to determine said predetermined fractional extent of a dimension.

8. The method as in claim 7 wherein the third arm measures 1/n of the dimension where 1/n is any fraction.

9. The method as in claim 8 wherein the third arm measures ½of the dimension.

10. The method as in claim 9 wherein the third arm measures ⅓of the dimension.

11. The method as in claim 7 wherein a gear drive train moves the third arm.

12. The method as in claim 7 wherein a screw drive mechanism moves the third arm.
